(19) United States
(12) Patent Application Publication
(10) Pub. No.: US 2025/0148459 A1
(43) Pub. Date: May 8, 2025

(54) BANKING TRANSACTIONS VIA MESSAGING APP

(71) Applicant: JP Morgan Chase Bank, N.A., New York, NY (US)

(72) Inventors: Shilpa M, Mysore (IN); Ajinkya Vharavadekar, Bangalore (IN); Pradeep Gangabhathina, Frisco, TX (US)

(73) Assignee: JP Morgan Chase Bank, N.A., New York, NY (US)

(21) Appl. No.: 18/794,400

(22) Filed: Aug. 5, 2024

(30) Foreign Application Priority Data
Aug. 4, 2023 (IN) 202311052549

(51) Int. Cl. G06Q 20/38; G06F 3/04817; G06F 3/0482; G06F 9/54; G06Q 20/32; G06Q 20/40

(52) U.S. Cl. CPC G06Q 20/386; G06F 3/04817; G06F 3/0482; G06F 9/54; G06Q 20/3255; G06Q 20/40145

(57) ABSTRACT

Provided is a system and method whereby a bank customer can engage a remote second party in a financial deal which is specific to a specific bank, all within the operational framework of an existing mobile phone messaging application which is other than the Specific Bank app. In certain circumstances, an embodiment of the present system and method entails two related elements: (i) having installed on the bank customer's mobile phone a Specific Bank mobile application which the bank customer normally uses for direct financial dealings with Specific Bank; and also (ii) having a Specific Bank extension application, installed on the mobile phone. The Specific Bank extension application (hereinafter, “extension app”) enables the provision of Specific Bank mobile application services from within the messaging application, so that the bank customer can engage in financial dealings with the second party via the messaging application.

### CROSS-REFERENCE TO RELATED APPLICATIONS

This application claims benefit to India Provisional Patent Application No. 202311052549, filed Aug. 4, 2023, the disclosure of which is incorporated herein in its entirety by reference.

### FIELD OF TECHNOLOGY

The present disclosure generally relates to processing financial transactions and data within financial institutions. More particularly, the present disclosure relates to processing a banking transaction or sharing banking information from within a mobile device messaging application (app).

### BACKGROUND

Financial institutions may include, for example, banks, brokerage houses, and investment firms. Many references and examples, used herein, include banks. Embodiments of the present disclosure, however, apply to financial institutions more broadly and are not limited to banks. By way of example, a bank customer may be in contact with a second-party person (such as a friend or business associate) via a mobile communications device, which may include a mobile phone, a tablet computer, or similar.

Person-to-person communications via a mobile phone is often implemented via messaging applications, typically employing text but often supplemented with images and video, as is well known in the art. A first party is identified herein as an established bank customer of a specific banking institution identified herein as Specific Bank. The bank customer may at some point in time be in communication via a suitable messaging application (e.g., the messaging app), with another party, identified herein as the second party. The second party may be or may not be a customer of Specific Bank.

The bank customer may wish to engage in a financial transaction with the second party, via the mobile phone, particularly via the messaging app. For the purposes of this document, a financial transaction may include conventional monetary transactions, such as purchases, bill payment, or financial transfers of funds or securities etc. However, financial transactions, or simply a “financial deal,” may be more broadly understood herein as including exchanges of financial information about a particular party; sharing of information about services offered by Specific Bank; and other transactional and data related operations pertaining to Specific Bank, and either, or both, of the bank customer and/or the second party.

In conventional usage, the bank customer may use the mobile phone's messaging app (e.g., a texting application) to communicate bank deal information (generally in the form of a text message) about the banking transaction or banking information to the second party. However, there may also be a requirement execute a deal, at may include, for example and out without limitation: sending an electronic bill; sending an electronic payment; providing the second party with information about various Specific Bank services; or providing the second party with actual access to Specific Bank services, and or other similar operations which may in some cases require interaction/communication between Specific Bank and the second party.

Conventionally, to execute a deal, the bank customer will refer the second party to a separate (i.e., different) mobile phone application. For example, the other mobile phone application may be specific to Specific Bank (for example, a custom-designed Specific Bank mobile phone app); or to a network (web-based) interface to Specific Bank; or to some other third-party application or service. This means in practice that either, or both, of the bank customer and the second party must activate, and interact with, the Specific Bank mobile phone application while possibly also maintaining communications/dialog via the message application. Further, if the second party is not a current customer of Specific Bank, the second party may need to first download the Specific Bank app (and then likely need to sign in or set up an account with Specific Bank, etc.). This can create awkward, inconvenient, and unnecessary mobile phone use.

### SUMMARY

Given the aforementioned deficiencies, what is needed are systems and methods that allow the bank customer to engage the second party in a financial deal specific to a Specific Bank. What is also needed are systems and methods for conducting a financial deal between remote parties and via a mobile phone messaging application.

In certain circumstances, an embodiment of the present system and method entails two related elements: (i) having installed on the bank customer's mobile phone a Specific Bank primary application which the bank customer normally uses for direct financial dealings with

Specific Bank; and also (ii) having a Specific Bank extension application, installed on the mobile phone. The Specific Bank extension application (hereinafter, “extension app”) enables the provision of Specific Bank mobile application services from within the messaging application, so that the bank customer can engage in financial dealings with the second party via the messaging application.

One embodiment includes a method for conducting a financial deal, including providing, from a mobile phone messaging application, an indication that the financial deal is to be provided as a message generated by the messaging application. The method also includes triggering, via the indication, an access via the messaging application to a specific bank extension application installed on the mobile phone, wherein the specific bank extension application is communicatively coupled on the mobile phone with the messaging application and a specific bank primary application which is also installed on the mobile phone. Additionally, the method includes, via the specific bank extension application, inserting into a text message generated by the messaging application a service of the specific bank primary application.

The method of any preceding clause, wherein the indication is triggered by a user selecting a banking icon displayed within the messaging application.

The method of any preceding clause, wherein the banking icon is part of an icon bar within the messaging application.

The method of any preceding clause, wherein the specific bank extension application runs in background mode and provides inter-process communication between the messaging application and the specific bank primary application.

The method of any preceding clause, wherein the specific bank extension application provides a graphical user interface (GUI) to the user within the messaging application.

The method of any preceding clause, wherein the GUI includes options for making payments, sending offers, and sharing banking information.

The method of any preceding clause, wherein the service of the specific bank primary application includes sending a payment confirmation receipt to the second party.

The method of any preceding clause, wherein the service of the specific bank primary application includes sending a biometric authentication request to the second party.

The method of any preceding clause, wherein the biometric authentication request includes a facial recognition widget, and wherein the service of the specific bank primary application includes sending a link to a specific bank offer to the second party.

Yet another embodiment includes an apparatus conducting a financial deal, comprising a plurality of memory components and a controller in communication with the plurality of memory components. The apparatus is configured to provide, from a mobile phone messaging application, an indication that a financial deal is to be provided in the form of a message generated by the messaging application and trigger, via the indication, an access via the messaging application to a specific bank extension application which is installed on the mobile phone, wherein the specific bank extension application is communicatively coupled on the mobile phone with both of the messaging application and a specific bank primary application which is also installed on the mobile phone. The apparatus is also configured to insert, via the extension application, into a text message generated by the messaging application a service of the specific bank primary application.

The apparatus of any preceding clause, wherein the indication is triggered by a user selecting a banking icon displayed within the messaging application.

The apparatus of any preceding clause, wherein the banking icon is part of an icon bar within the messaging application.

The apparatus of any preceding clause, wherein the specific bank extension application runs in background mode and provides inter-process communication between the messaging application and the specific bank primary application.

The apparatus of any preceding clause, wherein the specific bank extension application provides a graphical user interface (GUI) to the user within the messaging application.

The apparatus of any preceding clause, wherein the GUI includes options for making payments, sending offers, and sharing banking information.

The apparatus of any preceding clause, wherein the service of the specific bank primary application includes sending a payment confirmation receipt to the second party.

The apparatus of any preceding clause, wherein the service of the specific bank primary application includes sending a biometric authentication request to the second party.

The apparatus of any preceding clause, wherein the biometric authentication request includes a facial recognition widget, and wherein the service of the specific bank primary application includes sending a link to a specific bank offer to the second party.

Yet another embodiment includes a non-transitory computer-readable medium. The non-transitory medium stores instructions that, when executed by a processor, cause a mobile device to perform a method, the method comprising providing, from a mobile phone messaging application, an indication that a financial deal is to be provided in the form of a message generated by the messaging application. The method also includes triggering, via the indication, an access via the messaging application to a specific bank extension application which is installed on the mobile phone, wherein the specific bank extension application is communicatively coupled on the mobile phone with both of the messaging application and a specific bank primary application which is also installed on the mobile phone, and inserting into a text message generated by the messaging application, via the extension application, a service of the specific bank primary application.

The non-transitory computer-readable medium of any preceding clause, wherein the indication is triggered by a user selecting a banking icon displayed within the messaging application.

The non-transitory computer-readable medium of any preceding clause, wherein the banking icon is part of an icon bar within the messaging application.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 presents a drawing of a message communications model for the present system and method.

FIG. 2A illustrates an exemplary display from a banking application.

FIG. 2B illustrates the same exemplary display as from FIG. 2A, except as displayed in the context of a messaging application.

FIG. 3 illustrates another exemplary display from a banking application, displayed in the context of a messaging application.

FIG. 4 illustrates another exemplary display from a banking application, displayed in the context of a messaging application.

FIG. 5 illustrates another exemplary display from a banking application, displayed in the context of a messaging application.

FIG. 6 illustrates a variety of exemplary capabilities of a banking application extension application.

FIG. 7 illustrates a use case of an exemplary messaging scenario between elements of the present system and method.

FIG. 8 illustrates a series of screen displays which may be associated with the use case of FIG. 7.

FIG. 9 illustrates a use case of an exemplary messaging scenario between elements of the present system and method.

FIG. 10 illustrates a series of screen displays which may be associated with the use case of FIG. 9.

FIG. 11 illustrates a use case of an exemplary messaging scenario between elements of the present system and method.

FIG. 12 illustrates a series of screen displays which may be associated with the use case of FIG. 11.

### DETAILED DESCRIPTION

This disclosure describes systems, apparatuses, and methods related to creating or managing a financial deal, related to Specific Bank, between a Specific Bank customer and a second party, via a messaging application.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that software, process, electrical, and structural changes may be made without departing from the scope of the present disclosure.

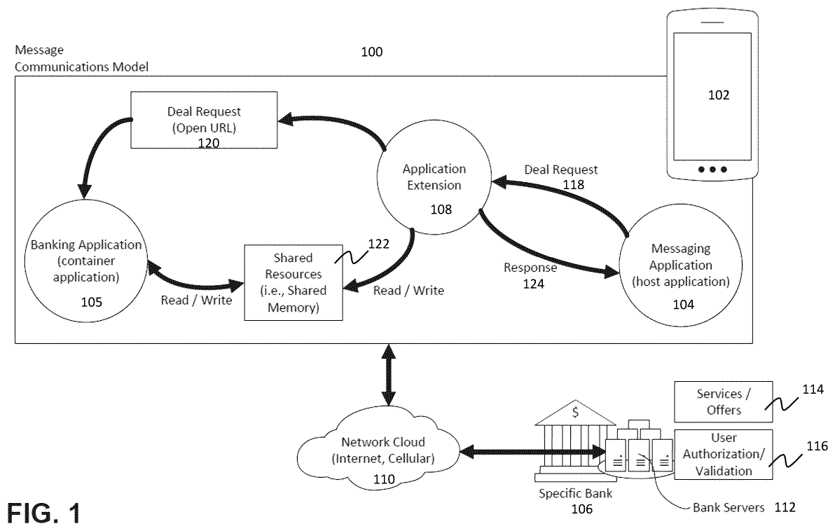

FIG. 1 is a block diagram illustration of a message communications model 100. The model 100 will be understood as being operative on a mobile phone 102 or similar personal communications device, with a computer controller, memory components, a display, and suitable radio frequency (RF) systems for communicating with a mobile phone network, WiFi network, or other network. Suitable application programs (“APK's”) may be installed on the mobile phone 102, with suitable inter-process communications implemented to enable the present system and method.

As depicted in FIG. 1, the elements of the communications model 100 include a messaging application 104 installed on the mobile phone 102, conventionally a text-messaging application, but typically with graphics, video, and/or audio capabilities as well. The messaging application 104 may also be referred to as the “host” application, since it is expected to host elements of the banking application, as discussed below.

A banking mobile application 105, specific to a particular financial institution, such as Specific Bank 106, is also installed on the mobile phone 102. The banking mobile application 105, also referred to as the “container application,” provides multiple services pertinent to customer interactions with the Specific Bank 106, as may be known in the art. Exemplary instances of such services are discussed further below.

An application extension 108 may also be installed on the mobile phone 102. In one embodiment, the application extension 108 runs entirely in background mode (i.e., the extension itself presents no visible interface or control per se to the user). The application extension 108 running entirely in background mode provides for inter-process communication between the messaging application 104 and the banking mobile application 105.

In an alternative embodiment, the application extension 108 will, in some operational contexts, provide a visible graphical user interface (GUI) to the bank customer, thereby supplementing what is displayed in the messaging application 104. For example, various options menus or option buttons for banking deals and banking services may be presented via the application extension 108. The application extension 108 then returns display control to the messaging application 104 as appropriate.

The application extension 108, therefore, provides for selected elements of the banking mobile application 105 to be displayed and/or to be operable within the context of the messaging application 104. In an alternative embodiment, the application extension 108 may be integrated into the software of the banking mobile application 105. In an alternative embodiment, the application extension 108 may be integrated into a messaging APK, provided by the Specific Bank 106, and which also substantially provides the typical services and capabilities of other third-party messaging applications.

In an embodiment, one or more of the messaging application 104, the application extension 108, and/or the banking mobile application 105 may communicate with a wide area network (WAN) such as the internet, via a so-called cloud 110, using standard mobile phone electronics and services. In turn, this enables the messaging application 104, the application extension 108, and/or the banking mobile application 105 to communicate with servers 112 of the Specific Bank 106. The Specific Bank servers 112 will host a variety of banking services/offers 114, as well as user authorization/validation services 116.

In an embodiment, the messaging application 104 may send requests 118 to the application extension 108. These requests may be for any of a variety of Specific Bank deals (again broadly understood as either bank services or bank information).

The application extension 108 will establish a connection with the banking mobile application 105. In one embodiment, the banking mobile application 105, uses a uniform resource locator (URL) 120 to open an internet connection directly with the Specific Bank 106. In another embodiment, the application extension 108 will establish a connection with locally shared resources 122 (i.e., data resources pre-stored in the mobile phone's memory maintained and updated as needed by the banking mobile application 105). Data read/write requests may be sent from the application extension 108 to the shared resources 122.

The deal request 118 is processed by the banking mobile application 105. The application extension 108 then transmits a deal response 124 to the messaging application 104. In an alternative embodiment, the application extension 108 actually presents a deal response on the mobile phone's 102 user interface, via the messaging application 104. The details of this are covered further below in this document.

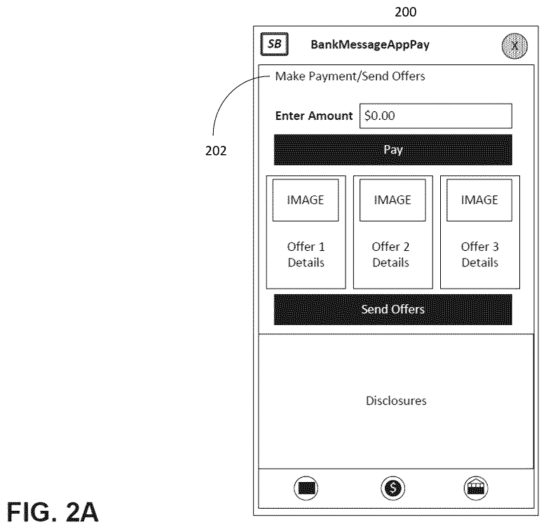

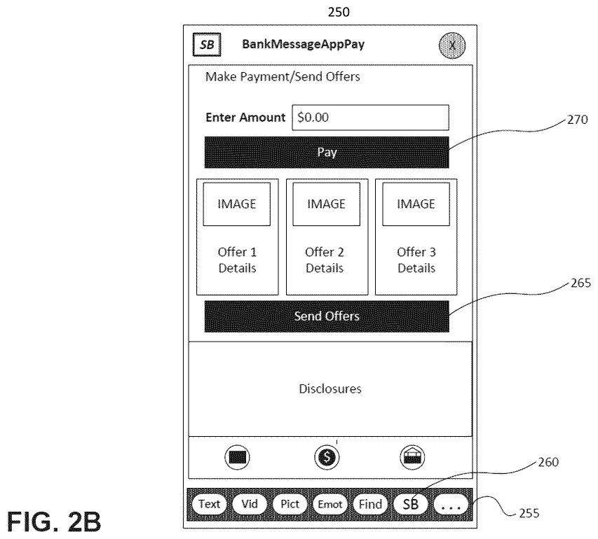

FIG. 2A illustrates an exemplary display 200 from a banking application such as the Specific Bank mobile application, as it may appear when used in the context of the banking mobile application 105. The exemplary display 200 may for example be utilized for making a payment 202 and may also include provision to present to the user various banking offers; these offers may in turn be sent to the recipient of the payment. Note that in this context, making the payment and/or sending the offers would require the use of the Specific Bank mobile application 105.

FIG. 2B illustrates nearly the same exemplary display 200 as from FIG. 2A, except as displayed in the context of the messaging application, and so relabeled as display 250. The ability to present the display 200 in the context of the messaging application 104 is made possible by the operation of the application extension 108.

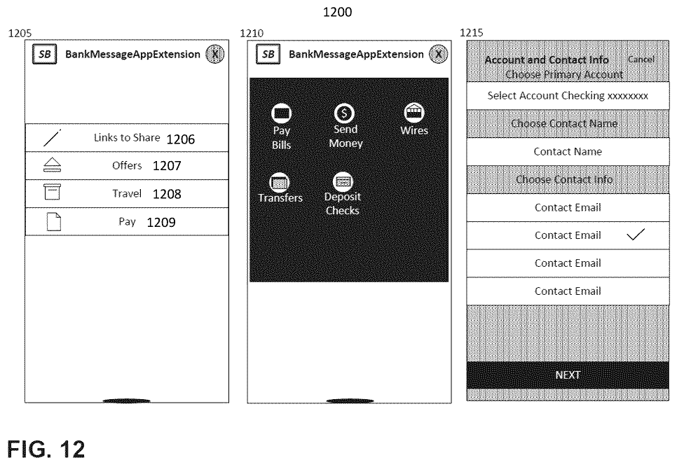

The display 250 of FIG. 2B includes an icon bar 255 which is an element of the messaging application (rather than an element of the banking application) 104. The exemplary icon bar 255 includes any number of icons that may be standard or commonplace for a texting/messaging application. In particular, the icon bar 255, as enabled or augmented by the application extension 108, includes a banking icon 260 (marked with “SB” for “Specific Bank”). When a user selects the banking icon 260, the user is presented with a display (see FIG. 12) which provides access to numerous bank mobile application features.

In the present context of FIG. 2B, it is apparent that the user had previously selected the banking icon 260; and then, via the options or menu presented, had selected an option such as “Pay” or “Make Payment,” or similar. This resulted in the presentation of the present BankMessage AppPay display 255, which allows for making a payment via the messaging application 104.

Note also that the display includes a “Pay” button 270 and a “Send Offers” button 265. The mobile phone user may select either button, in the context of the messaging application, to send an indicated payment (“Enter Amount”) or send the offers shown in the respective Offer Details images. As implemented via the application extension 108, it is thus possible to execute banking transactions and deals from within the messaging application 104.

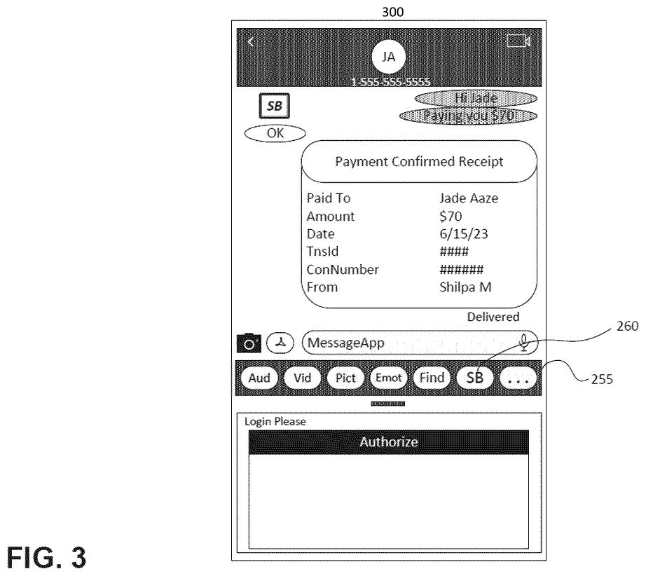

FIG. 3 illustrates another exemplary display 300 from the banking mobile application 105, displayed in the context of the messaging application 104. The display 300 may for example pertain to a payment confirmation receipt, issued by Specific Bank 106 for the benefit of a payee (“Jade Aaze” in the example shown). The receipt is displayed in the context of the messaging application 104, after being sent to the recipient JA via the messaging application 104.

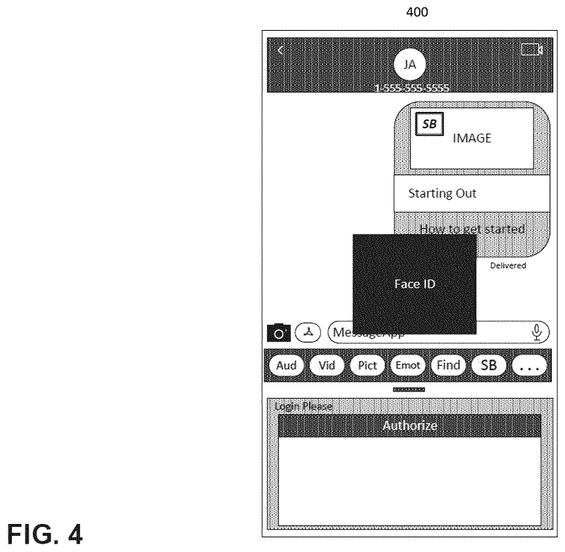

FIG. 4 illustrates another exemplary display 400 from the banking mobile application 105, displayed in the context of the messaging application 104. By way of example, the display 400 may pertain to obtaining a biometric identification of a person, such as a facial recognition of the second party (the recipient of the text message). By sending a facial recognition widget of the Specific Bank 106 to the second party, the bank customers can enable the second party to provide for biometric identification of themselves.

In the embodiments, the second party's biometric data could already be stored by the Specific Bank 106 on their servers 112, if the second party is already a customer of the Specific Bank 106. The facial recognition data may be obtained on a first-time basis via the current transaction. Theoretically, the issuer would have captured and stored the second party's facial recognition print, or other biometric data, during an identification process when a credit card or bank card was initially issued. During an identification (ID) authentication process, a picture of a live version of the second party's face would be captured by their mobile phone camera and compared with a digitized stored version of the customer's face print.

In one embodiment, when the messaging application 104 sends the biometric authentication widget to the second party, the second party can engage in biometric identification via a direct link with the Specific Bank 106. In an alternative embodiment, biometric validation data may be stored on the bank customer's phone, for example as part of the shared resources (see FIG. 1), possibly in encrypted form. The second party may validate themselves directly to the mobile phone 102 of the banking customer.

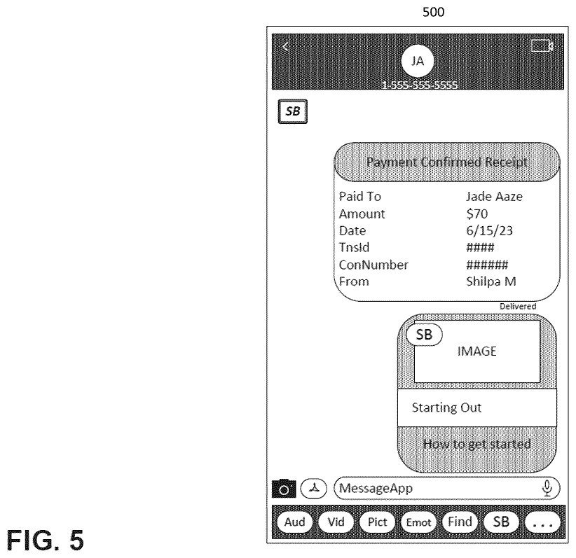

FIG. 5 illustrates another exemplary display 500 from the banking mobile application 105, displayed in the context of the messaging application 104. The figure illustrates a Payment Confirmation Receipt by the Specific Bank 106 of a payment made by the bank customer to the second party. The receipt can be sent as part of a message from the bank customer to the second party which is sent via the messaging application 104.

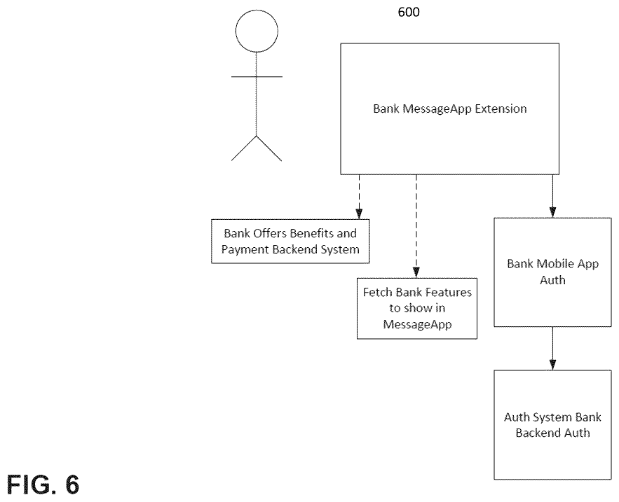

FIG. 6 illustrates a variety of exemplary capabilities 600 of the application extension 108. The capabilities 600 are exemplary only and are in no way limiting. The capabilities 600 enable the messaging application 104 to offer a variety of banking capabilities via the messaging application 104, including for example:
1. offering bank benefits;
2. providing bank back-end payment systems;
3. displaying a variety of bank features, and possibly offering associated capabilities, via the messaging application;
4. offering second party authentication and/or authorization via the bank mobile application; and
5. offering second party authentication and/or authorization via the bank's back-end systems.

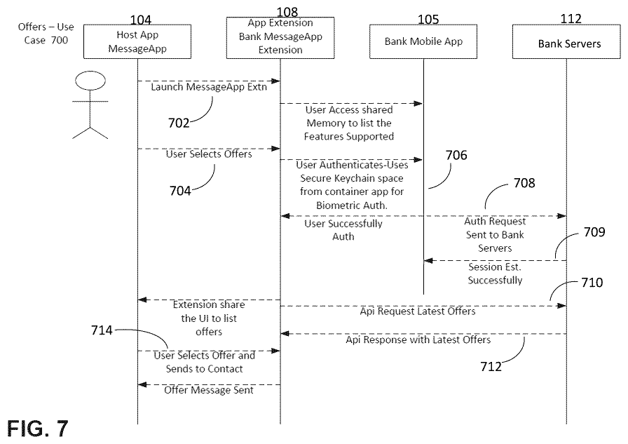

FIG. 7 illustrates a use case 700 in the form of an exemplary messaging scenario between elements of the present system and method. Sequentially, over time:

At step 702, the messaging application 104 launches the application extension 108. At step 704, the user selects the Specific Bank icon 260 on the messaging application display (not noted in the drawing) to obtain access to a list of supported banking features. The user selects a feature on the host messaging application 104, for example, “Offers.” At step 706, the user authenticates his/her identity to the Specific Bank 106. As depicted in FIG. 7, at step 708 authentication entails messaging back and forth between the application extension 108, the bank mobile application 105, and bank servers 112 of the Specific Bank 106.

Upon authentication, a communications session is successfully established between the bank servers 112 and the bank mobile application 105 at step 709. The application extension 108 shares with the bank mobile application 105 a user interface listing various bank offers. At step 710, upon a banking customer request via the user interface, the application extension 108 requests from the bank servers 112 the latest offers.

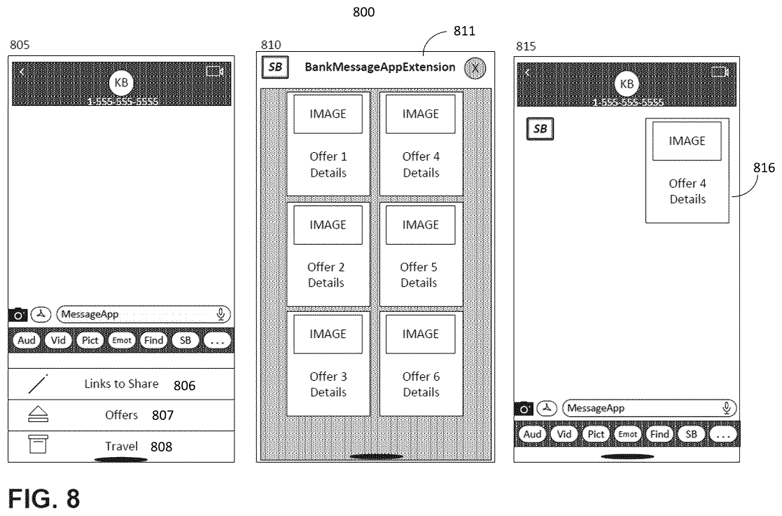

At step 712, the bank servers 112 respond with the latest offers. Via the messaging application user interface, the user selects an offer and sends it to the second party at step 714. FIG. 8 illustrates a series of screen displays which may be associated with the use case 700 of FIG. 7.

An exemplary first screen display 805 shows the messaging application 104 in a split screen mode. The bottom of the screen presents links for various Specific Bank options, such as “Links To Share 806”, “Offers 807”, and “Travel 808.” In the use case 700, the bank customer selects “Offers.”

An exemplary second screen display 810 may be presented in a new window, for example, a “BankMessageAppExtension 811” display which may be presented by the application extension 108. The display 810 may present multiple offers which can be sent to the second party. The bank customer will select an offer to be sent.

In an alternative embodiment, the visual contents and the second screen display 810 may be presented, in reduced-size form, in a split screen within the context of the messaging application 104.

In the present instance, the bank customer has selected ‘Offer 4 Details’ 816. An exemplary third screen display 815 shows ‘Offer 4 Details’ 816, presented in the context of the messaging application 104, as part of a message to be sent. When ready, for example after adding additional text, the customer may send ‘Offer 4 Details’ 816 to the second party as part of a message. In some embodiments, the graphic/button of Offer 4 Details 816 may include a link, so that the second party can actually connect directly to Specific Bank's back-end servers to learn more about Offer 4 Details 816, and possibly to sign up for Offer 4 Details 816.

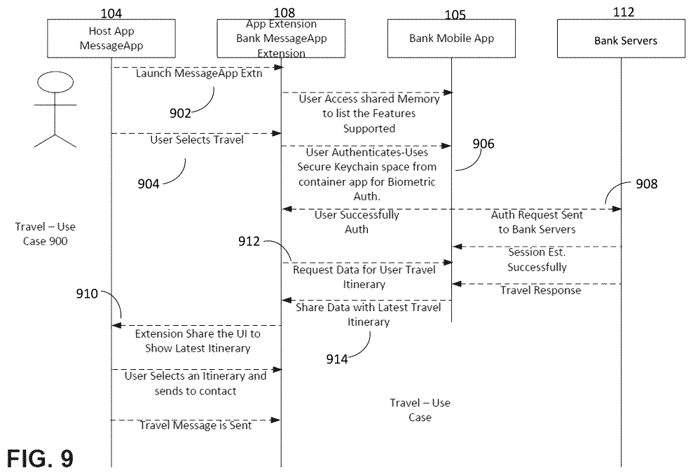

FIG. 9 illustrates a use case 900 in the form of an exemplary messaging scenario between elements of the present system and method. At step 902, the messaging application launches the application extension 108. The user selects the Specific Bank icon 260 on the messaging application display (not noted in the drawing) to obtain access to a list of supported banking features.

At step 904, the user selects a feature on the host messaging application 104, for example, “Travel.” At step 906, the user authenticates his/her identity to the Specific Bank 106. As noted at step 908, this entails messaging back and forth between the application extension 108, the bank mobile application 105, and the bank servers 112. In one embodiment, the container application may present to the bank customer a separate user-interface for user authentication.

Upon authentication, a communications session is successfully established between the bank servers 112 and the bank mobile application 105. At step 910, the application extension 108 shares with the bank mobile application 105 a user interface listing various bank offers. Upon a banking customer request via the user interface, the application extension 108 requests from the bank servers 112 the user travel itinerary. The bank servers 112 respond with the latest travel itinerary.

At step 912, via the messaging application user interface, the user selects a travel itinerary and sends it to the second party. At step 914, the messaging application 104 sends the travel itinerary message to the second party.

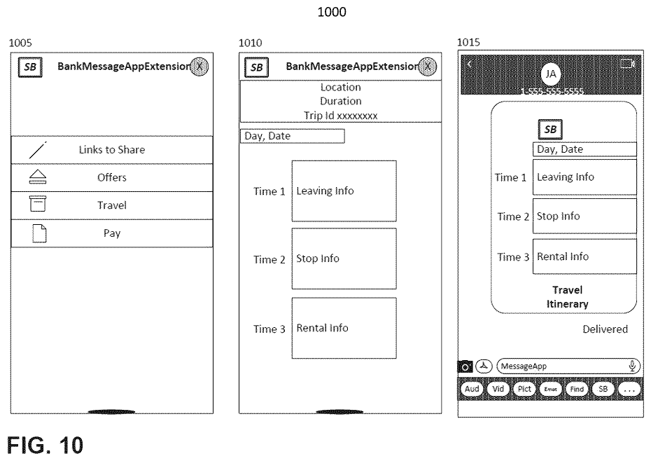

FIG. 10 illustrates a series of screen displays 1000 which may be associated with the use case 900 of FIG. 9.

An exemplary first screen display 1005 shows the application extension 108 offering four options for banking services to be made available via the messaging application 104. In the use case 900, the bank customer selects “Travel.”

An exemplary second screen display 1010 may be presented which shows the kinds of travel information that may be available for a trip which was scheduled or paid for via the Specific Bank 106. In FIG. 10, Time 1 and Time 2 within the screen display 1010 may depict different types of information related to an itinerary for the trip. By way of example only, and not limitation, Time 1 may represent a time when the bank customer leaves their home or picks up a traveling companion to catch a particular flight. Time 2 may represent a time when the bank customer arrives at a destination or ends a particular phase of the trip. Time 3 may represent a time when the bank customer picks up a rental car. In the example screen display 1010, the bank customer will select one or more types of information to be shared via the messaging application 104.

An exemplary third display screen 1015 may then be presented by the messaging application 104. The third display shows the trip information, which has been delivered via the messaging application 104 to the second party, such as the Time 1, Time 2, and Time 3 information along with place, Trip ID, and flight information etc.

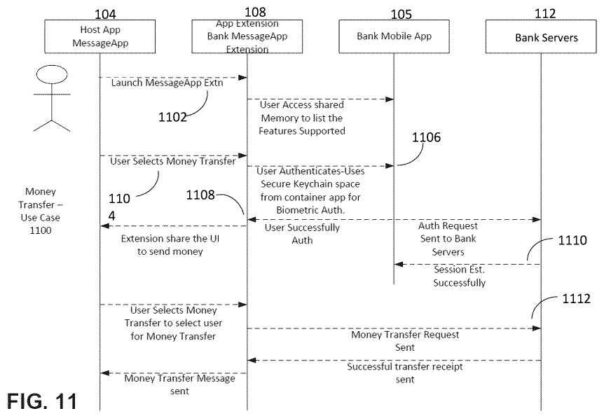

FIG. 11 illustrates a use case 1100 in the form of an exemplary messaging scenario between elements of the present system and method. At step, 1102, the messaging application 104 launches the application extension 108. The user selects the Specific Bank icon 260 on the messaging application display to obtain access to a list of supported banking features. At step 1104, the user selects a feature on the host messaging application 104, for example, “Money Transfer.”

At step 1106, the user authenticates his/her identity to the bank. As depicted in FIG. 11, this entails messaging back and forth between the application extension 108, the bank mobile application 105, and the bank servers 112. In one embodiment, the container application may present to the bank customer a separate user-interface for user authentication.

Upon authentication 1108, a communications session 1110 is successfully established between the bank servers 112 and the bank mobile application 105. The application extension 108 shares with the bank mobile application 105 a user interface listing various bank offers.

Upon a banking customer request via the user interface, the application extension 108 requests from the bank servers 112 a display for money transfers and requests a money transfer which is sent from the application extension 108 to the bank servers 112. After successful completion of the money transfer, the bank servers 112 send a receipt to the application extension 108. In step 1112, via the messaging application user interface, the user sends a money transfer receipt message to the second party.

FIG. 12 illustrates a series of screen displays which may be associated with the use case 1100 of FIG. 11.

An exemplary first screen 1205 display shows the application extension presenting a variety of bank deal options to the bank customer. These options include Links To Share 1206, Offers 1207, Travel 1208, and Pay 1209. In the present use case 1100 of FIG. 11, the user will select Pay.

An exemplary second screen display 1210 shows the application extension 108 presenting a variety of payment options to the bank customer. In the present use case 1100 of FIG. 11, the user will select Send Money.

An exemplary third screen display 1215 shows the messaging application 104 presenting a variety of data and data fields pertinent to sending money to the second party. The fields shown are exemplary only and may not include all needed data fields (for example, an “Amount” field is not shown but would be included on this or a prior/subsequent display screen).

In one embodiment, the present system and method provide, from a mobile phone messaging application, an indication that a financial deal is to be provided in the form of a message generated by the messaging application. In some embodiments, the indication may be triggered by a bank customer using the mobile phone, and who selects a banking icon or similar icon displayed in the context of the messaging application. The selection of the banking icon triggers access to a banking application and/or shared banking memory, via an extension application which has been previously installed on the mobile phone.

The extension application communicates, via suitable application specific interfaces (APIs) on the mobile phone, with the messaging application and a bank primary application previously installed on the mobile phone.

Via the extension application, access is obtained to suitable banking deals in the bank application. Appropriate displays and access widgets, such as buttons or data fields, are inserted into a text message generated by the messaging application, thereby providing access to one or more specific bank deals of the bank primary application.

The present system and method pertains to an application extension for a banking application. The application extension may be an extension to a banking application executing, for example, the mobile phone. The extension of the banking application can run as part of, or in the context of, a different host application, such as a messaging application. In this way, features of the banking application may be run from within the messaging application, without any requirement for the user to log into the banking application.

Such an extension enhances the experience of the host application (the messaging application) by offering banking services via the messaging application. Banking services offered via the messaging application may include payments, bank benefits, and offers which may be shared with second party message recipients via the messaging application. These benefits, services, and offers, referred to herein as the deals, may be offered both to existing bank customers and non-bank customers, via the messaging application.

By way of example, and not limitation, a Zelle payment may be made to the second party recipient via the messaging application, and the message sent to the second party may include a payment notification. Credit card benefits and travel bookings, done via the bank, may also be handled via the messaging application. Bills and other transactions may be shared via the messaging application.

A bank user may be authorized, for example using facial identification, via the messaging application. Payments may be made, or payments may be shared between the bank customer and the second party message recipient, via the messaging application. If payments are made, it is possible to share a payment receipt with the second party message recipient via the messaging application.

In general, by means of the extension application, it is possible to increase bank customer engagement the Specific Bank without launching the Specific Bank application. This is possible because the extension application makes the resources of the Specific Bank application available to the bank customer from within the messaging application.

Operationally, the extension application may employ a split screen mode to enable the bank customer to interact with the bank application while using the messaging application. For example, the messaging application may be split into two different displays, both visible to the bank customer at the same time. A first part of the screen displays modes, options, and tools pertinent to general messaging, while a second part of the split screen displays modes, options, information, and tools pertinent to banking operations.

Operationally, the extension application may obtain and/or maintain banking information in either (or both) of two approaches. In one approach, banking information may be stored locally on the mobile phone, in a memory space shared by the extension application and the banking application. The shared memory between the banking application and the extension access may hold Static data, such as list of offers, or payment options.

In the other approach, the extension application may obtain banking information dynamically by connecting to the bank's back-end systems, possibly employing on-phone services of the banking application (such as login and authentication services).

In an embodiment, it will be noted that the application extension enables the user of the messaging application to access bank deals and services without needing to open the banking application. (The application extension may, however, employ banking application services in the background.) The messaging extension may be uploaded and installed as part of the same process as uploading and installing the banking application. In an embodiment, user authentication is performed in conjunction with the bank back-end system.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for conducting a financial deal, comprising:
providing, from a mobile phone messaging application, an indication that the financial deal is to be provided as a message generated by the messaging application;
triggering, via the indication, an access via the messaging application to a specific bank extension application installed on the mobile phone, wherein the specific bank extension application is communicatively coupled on the mobile phone with the messaging application and a specific bank primary application which is also installed on the mobile phone; and
via the specific bank extension application, inserting into a text message generated by the messaging application a service of the specific bank primary application.

2. The method of claim 1, wherein the indication is triggered by a user selecting a banking icon displayed within the messaging application.

3. The method of claim 2, wherein the banking icon is part of an icon bar within the messaging application.

4. The method of claim 1, wherein the specific bank extension application runs in background mode and provides inter-process communication between the messaging application and the specific bank primary application.

5. The method of claim 1, wherein the specific bank extension application provides a graphical user interface (GUI) to a user within the messaging application.

6. The method of claim 5, wherein the GUI includes options for making payments, sending offers, and sharing banking information.

7. The method of claim 1, wherein the service of the specific bank primary application includes sending a payment confirmation receipt to a second party.

8. The method of claim 1, wherein the service of the specific bank primary application includes sending a biometric authentication request to a second party.

9. The method of claim 8, wherein the biometric authentication request includes a facial recognition widget; and
wherein the service of the specific bank primary application includes sending a link to a specific bank offer to the second party.

10. An apparatus conducting a financial deal, comprising:
a plurality of memory components; and
a controller in communication with the plurality of memory components and configured to:
provide, from a mobile phone messaging application, an indication that the financial deal is to be provided as a message generated by the messaging application;
trigger, via the indication, an access via the messaging application to a specific bank extension application installed on the mobile phone, wherein the specific bank extension application is communicatively coupled on the mobile phone with the messaging application and a specific bank primary application also installed on the mobile phone; and
insert, via the specific bank extension application, into a text message generated by the messaging application a service of the specific bank primary application.

11. The apparatus of claim 10, wherein the indication is triggered by a user selecting a banking icon displayed within the messaging application.

12. The apparatus of claim 11, wherein the banking icon is part of an icon bar within the messaging application.

13. The apparatus of claim 10, wherein the specific bank extension application runs in background mode and provides inter-process communication between the messaging application and the specific bank primary application.

14. The apparatus of claim 10, wherein the specific bank extension application provides a graphical user interface (GUI) to a user within the messaging application.

15. The apparatus of claim 13, wherein the GUI includes options for making payments, sending offers, and sharing banking information.

16. The apparatus of claim 10, wherein the service of the specific bank primary application includes sending a payment confirmation receipt to a second party.

17. The apparatus of claim 10, wherein the service of the specific bank primary application includes sending a biometric authentication request to a second party.

18. The apparatus of claim 17, wherein the biometric authentication request includes a facial recognition widget; and
wherein the service of the specific bank primary application includes sending a link to a specific bank offer to the second party.

19. A non-transitory computer-readable medium storing instructions that, when executed by a processor, cause a mobile device to perform a method, the method comprising:
providing, from a mobile phone messaging application, an indication that a financial deal is to be provided as a message generated by the messaging application;
triggering, via the indication, an access via the messaging application to a specific bank extension application installed on the mobile phone, wherein the specific bank extension application is communicatively coupled on the mobile phone with the messaging application and a specific bank primary application installed on the mobile phone; and
inserting into a text message generated by the messaging application, via the extension application, a service of the specific bank primary application.

20. The non-transitory computer-readable medium of claim 19, wherein the indication is triggered by a user selecting a banking icon displayed within the messaging application.
